(19) United States
(12) Patent Application Publication
(10) Pub. No.: US 2011/0069637 A1
(43) Pub. Date: Mar. 24, 2011

(54) System and Method for Control Channel Search Space Location Indication for a Relay Backhaul Link

(75) Inventors: Deping Liu, Schaumburg, IL (US); Yufei Blankenship, Kildeer, IL (US)

(73) Assignee: FutureWei Technologies, Inc., Plano, TX (US)

(21) Appl. No.: 12/880,930

(22) Filed: Sep. 13, 2010

Related U.S. Application Data
(60) Provisional application No. 61/243,944, filed on Sep. 18, 2009.

(51) Int. Cl. H04L 12/28

(52) U.S. Cl. 370/254

(57) ABSTRACT

A system and method for providing a control channel search space location indication for a relay backhaul link are provided. A method for controller operation includes configuring a set of resource blocks for transmission of a relay control channel for a relay node, and transmitting the configuration of the set of resource blocks to the relay node using high layer signaling. The relay control channel is located within the set of resource blocks.

This application claims the benefit of U.S. Provisional Application No. 61/243,944, filed Sep. 18, 2009, entitled “System and Method for Control Channel Search Space Location Indication for a Relay Backhaul Link,” which application is hereby incorporated herein by reference.

### TECHNICAL FIELD

The present invention relates generally to wireless communications, and more particularly to a system and method for providing a control channel search space location indication for a relay backhaul link.

### BACKGROUND

A relay node (RN) is considered as a tool to improve, e.g., the coverage of high data rates, group mobility, temporary network deployment, the cell-edge throughput and/or to provide coverage in new areas. The RN is wirelessly connected to a wireless communications network via a donor cell (also referred to as a donor enhanced Node B (donor eNB or D-eNB)).

There may be several kinds of RNs, one is that serves as an eNB to one or more User Equipment (UE). A wireless link between the RN and its served UEs is referred to as an access link and a link between the RN and its donor eNB is named a relay backhaul link.

To a UE that is being served by the RN, the RN appears identical to an eNB, scheduling uplink (UL) and downlink (DL) transmissions from and to the UE over an access link.

The relay backhaul link of an in-band RN typically operates in the same frequency spectrum as the access link. Therefore, due to the RN's transmitter causing interference to its own receiver, simultaneous “donor eNB-to-RN and RN-to-UE” or “UE-to-RN and RN-to-donor eNB” transmissions on the same time-frequency resource may not be feasible unless sufficient isolation of outgoing and incoming signals is provided, e.g., by means of specific, well separated, and well isolated antenna structures.

In Long Term Evolution (LTE) Advanced proposed by the Third Generation Partnership Project (3GPP), a solution to the interference problem may be handled by operating the RN such that the RN is not transmitting to UEs when it is supposed to receive data from the donor eNB to create gaps in the RN-to-UE transmission. These gaps during which UEs (including Release-8 (Rel-8) UEs) are not supposed to expect any RN transmission are created by configuring Multi-Media Broadcast over a Single Frequency Network (MBSFN) subframes. RN-to-donor eNB transmissions can be facilitated by not allowing any UE-to-RN transmissions in some subframes.

In the donor eNB-to-RN relay backhaul link transmission, the Type 1 RN cannot receive a normal eNB control region. Rather the control signals from the donor eNB to the RN reside in a control region dedicated to RNs only. Since the control region for RNs may vary from subframe to subframe, there is a need of mechanisms to notify the RNs where the RN's control region is located.

### SUMMARY OF THE INVENTION

These and other problems are generally solved or circumvented, and technical advantages are generally achieved, by embodiments of a system and method for providing a control channel search space location indication for a relay backhaul link.

In accordance with an embodiment, a method for controller operation is provided. The method includes configuring a set of resource blocks for transmission of a relay control channel for a relay node, and transmitting the configuration of the set of resource blocks to the relay node using high layer signaling. The relay control channel is located within the set of resource blocks.

In accordance with another embodiment, a method for relay operation is provided. The method includes receiving a control channel indication, and detecting the relay control channel at a set of configured resource blocks specified by the resource block configuration. The control channel indication indicates a resource block configuration for a relay control channel.

In accordance with another embodiment, a transmission frame is provided. The transmission frame includes a control region, a search space of a relay node, a relay control channel, and a relay data channel. The control region includes information specifically addressed to communications devices other than relay nodes, the frequency location of the search space is signaled to the relay nodes by a controller, and the relay control channel includes control information specifically addressed to the relay node, and the relay control channel occupies a subset of the search space. The relay data channel includes data specifically addressed to the relay node.

In accordance with another embodiment, a relay is provided. The relay includes a receiver, a location unit coupled to the receiver, and a detector coupled to the location unit. The receiver receives transmitted information, the location unit determines a location of a relay control channel, and the detector detects the relay control channel within the location.

An advantage of an embodiment is that a relay node may be told where to search for its control channel, which may allow for the placement of the control channel in a variety of places as well as reduce the searching that the relay node must perform to find its control channel. Thereby increasing the overall flexibility of a communications system as well as reducing the load on the relay node.

A further advantage of an embodiment is that a variety of techniques for specifying a search space for a relay node's control channel are provided. Therefore, it may be possible to provide a wide range of flexibility and precision in specifying the search space, potentially with a trade-off in signaling overhead.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a communications system;

FIGS. 2a through 2d are diagrams of frame structures of uplink and downlink communications links;

FIG. 3 is a diagram of a frame structure of a downlink communications link;

FIG. 4 is a diagram of a frame structure of a downlink communications link;

FIG. 5 is a diagram of a sequence of frames of a downlink communications link, wherein the frames include indications of search space for a RN joining a donor eNB;

FIG. 6 is a diagram of a sequence of frames of a downlink communications link, wherein the frames include indications of search space for a RN already operating with a donor eNB;

FIG. 7 is a flow diagram of RN operations;

FIG. 8 is a flow diagram of RN operations in detecting a location of a relay control channel; and

FIG. 9 is a diagram of a relay.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a Third Generation Partnership Project (3GPP) Long Term Evolution (LTE) compliant communications system with relay nodes. The invention may also be applied, however, to other communications systems, such as WiMAX compliant communications systems, that support relay nodes.

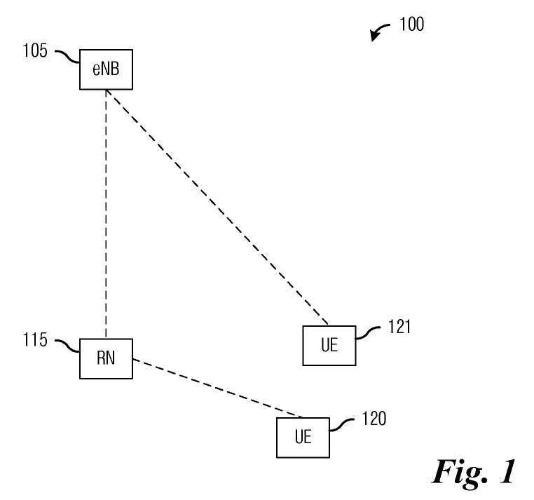

FIG. 1 illustrates a communications subsystem 100. Communications subsystem 100 includes an eNB 105. Communication subsystem 100 also includes a RN 115. As discussed earlier, a RN may be used to improve data transfer rates, mobility, coverage, throughput, and so forth. A RN is connected through a wireless connection (“wireless relay backhaul”) to an eNB, wherein the eNB that is being used to wirelessly connect the RN is referred to as a donor eNB. For example, RN 115 is connected to eNB 105 through a wireless relay backhaul and eNB 105 is the donor eNB of RN 115. Communication subsystem 100 also includes one or more UEs, such as UE 120 and UE 121. As example, UE 120 represents a UE that is served directly by a RN while UE 121 represents a UE that is served directly by the donor eNB. An eNB can simultaneously serve RN(s) and its own UEs, and a RN can serve several UEs.

To the eNB, the RNs are similar to its other UEs in many aspects. To the UE served by RN, an eNB or RN may be functionally equivalent, with the RN appearing the same as an eNB to its UE (e.g., UE 120). When the UE has information to transmit, the UE must request wireless resource and can transmit after receiving an UL scheduling grant of the wireless resource from eNB. Similarly, when there is information for the UE, the eNB sends similar downlink scheduling assignment of the wireless resource to indicate to the UE that the information is being sent and where and how to detect the information.

For 3GPP LTE and LTE-A, a radio frame is 10 ms long and consists of 20 slots of length 0.5 ms each, numbered from 0 to 19. A subframe is defined as two consecutive slots where subframe i consists of slots 2i and 2i+1. Orthogonal Frequency Division Multiplex (OFDM) is used in downlink (DL), and Single Carrier—Frequency Division Multiple Access (SC-FDMA) is used in uplink (UL). The basic LTE DL physical resource may be seen as a time-frequency resource grid, where each resource element (RE) corresponds to one OFDM subcarrier with frequency-domain index k during one OFDM symbol interval with time-domain index l, (k,l). Resource blocks (RBs) are used as the minimum resource granularity to allocate UE wireless resources for data transmission.

Both physical and virtual RBs are defined in LTE and LTE-A. A physical RB is defined as N_{symb}^{DL} consecutive OFDM symbols in the time domain and N_{sc}^{RB} consecutive subcarriers in the frequency domain, corresponding to one slot in the time domain and 180 kHz in the frequency domain. Thus a physical resource block consists of N_{symb}^{DL}×N_{sc}^{RB} REs.

A virtual resource block is defined of the same size as a physical resource block. Two types of virtual resource blocks are defined: Virtual resource blocks of localized type and Virtual resource blocks of distributed type. For each type of virtual resource blocks, a pair of virtual resource blocks over two slots in a subframe is assigned together by a single virtual resource block number, n_{VRB}. Virtual resource blocks of localized type are mapped directly to physical resource blocks such that virtual resource block n_{VRB} corresponds to physical resource block n_{PRB}=n_{VRB}. Virtual resource blocks are numbered from 0 to N_{VRB}^{DL}−1, where N_{VRB}^{DL}=N_{RB}^{DL}. Virtual resource blocks of distributed type are mapped to physical resource blocks in terms of the parameter N_{gap} by a unit of VRB number interleaving.

In a regular DL subframe, the OFDM symbols are divided into a control region (for Physical Downlink Control Channels (PDCCH)) and a data region (for Physical Downlink Shared Channels (PDSCH)), etc. The control region is composed of one to three OFDM symbols and the data region appears after the control region. All the PDCCH's within the control region are for the indication of their corresponding PDSCH or PUSCH, the allocated resources, format, etc. So a UE must first detect its PDCCH(s), then acquire its corresponding PDSCH and/or PUSCH. The multiple PDCCHs are multiplexed in the control region. A UE blindly searches for its PDCCH in its search space residing in the control region until finding its PDCCH, or finishes searching the its search space without detecting any which means there is no PDCCH for the UE in this subframe.

The control region consists of a set of Control Channel Elements, numbered from 0 to N_{CCE,k}−1, where N_{CCE,k} is the total number of CCEs in the control region of subframe k. One CCE consists of 9 resuource-element grougps(REGs)

The UE shall monitor a set of PDCCH candidates for control information in every non-DRX subframe, where monitoring implies attempting to decode each of the PDCCHs in the set according to all the monitored DCI formats. The set of PDCCH candidates to monitor are defined in terms of search spaces, where a search space sₖ^{(L)} at aggregation level Lε{1,2,4,8} is defined by a set of PDCCH candidates. The UE shall monitor one common search space at each of the aggregation levels 4 and 8 and one UE-specific search space at each of the aggregation levels 1, 2, 4, 8. The common and UE-specific search spaces may overlap. The start point of the search space is defined in terms of UE RNTI, subframe number, system bandwidth; the size of the search space is defined in terms of aggregation level.

The mapping of PDCCH to resource elements is defined by operations on quadruplets of complex-valued symbols. The block of quadruplets shall be permuted according to the sub-block interleaver with the following exceptions: the input and output to the interleaver is defined by symbol quadruplets instead of bits; interleaving is performed on symbol quadruplets instead of bits. The block of quadruplets of the output of the interlever shall be cyclically shifted, and the mapping of the block of quadruplets is defined in terms of resource-element groups.

The legacy UEs (Rel-8) and new advanced UEs may coexist in a cell. To be backwards compatible with Rel-8 UEs, the RN and UEs served by RNs follow the same Rel-8 subframe structure in the access link (RN⇄UE). However, when the DL subframe is used in donor eNB→RN backhaul link, the subframe structure needs to be defined further to accommodate both the RN and a regular UE operating in the donor eNB cell in a same subframe.

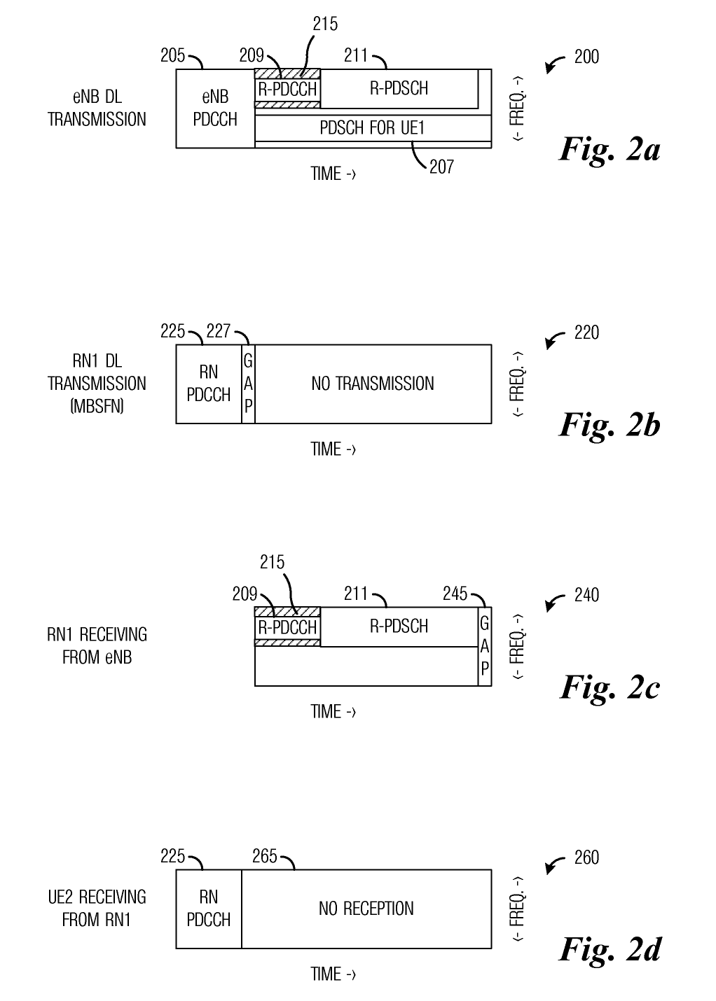

FIGS. 2a through 2d illustrate a frame structure (transmission frames) of the backhaul link and the access link in a subframe where downlink backhaul transmission occurred. In this example, UE1 is a regular UE directly served by the eNB. RN1 is a relay node attached to the donor eNB. UE2 is a UE served by RN1.

When a MBSFN subframe is used in the RN1→UE link to create gaps to allow the relay backhaul (donor eNB→RN1) link, the RN1 first sends control OFDM symbols in access link to the UEs (such as UE1) then the RN1 turns around to receive from the donor eNB in the relay backhaul link. This means that the RN1 may not be able to receive the control region that is simultaneously sent by the donor eNB. Thus the subframe structure needs to be defined further to accommodate both the RN and a regular UE operating in the donor eNB cell in a same subframe. It is expected that there should be a control region dedicated to RNs (rather than regular UEs), in addition to the normal control region in a downlink subframe sent by eNB.

FIG. 2a illustrates a frame structure for a downlink (DL) link 200 transmission from an eNB to a RN. DL link 200 includes a control region 205 and a data region 207. Although region 205 is labeled as the eNB physical downlink control channel (PDCCH) since PDCCH is the focus of the invention, the control region may contain other types of control channels. Similarly, for simplicity the data region is labeled with physical downlink shared channel (PDSCH). Since DL link 200 is also a DL relay backhaul link, DL link 200 includes some REs dedicated for use as the DL relay backhaul link, such as relay-physical downlink control channel (R-PDCCH) 209 and relay-physical downlink shared channel (R-PDSCH) 211.

DL link 200 includes a control region for RNs: the search spaces of RNs (an example shown as search space 215 of a RN), which follows control channel 205, occupying a set of subcarriers of one or several OFDM symbols. Search space 215 may be specified by its frequency location. R-PDCCH 209 (if present) of the RN is located in the RN's search space 215. Search space 215 may be referred to as a virtual system bandwidth, which, in general, may be considered to be a set of RBs that can be semi-statically configured for potential R-PDCCH transmission. In other words, time domain parameters of the set of RBs may be semi-statically configured. Like PDCCH 205, R-PDCCH 209 provides information to support the transmission of DL and UL transport channel. R-PDCCH 209 may include information such as: resource assignment, modulation and coding system (MCS), Hybrid Automatic Repeat Request (HARM) information, and so on. That is, R-PDCCH 209 contains all the information for detecting and decoding the PDSCH.

FIG. 2b illustrates an MBSFN frame structure for a DL link 220 transmission from a RN to a UE which is time-aligned with DL link 200. DL link 220 includes a PDCCH 225 sent by RN, a gap 227, and a period of no transmission. Gap 227 may be inserted to allow radio frequency (RF) circuitry time to switch from transmission status to reception status, for example.

FIG. 2c illustrates a frame structure of a DL link 240 transmission from an eNB to a RN as seen by the RN which is time-aligned with DL links 200 and 220. At the RN, DL link 200 transmitted by the eNB may be detected by the RN as simply R-PDCCH 209 (located in search space 215) and R-PDSCH 211. A gap 245 is also needed by the RN to finish the switch from reception status to transmission status before the next normal subframe start in the access link.

FIG. 2d illustrates a frame structure of a DL link 260 transmission (MBSFN subframe) from a RN to a UE as seen by the UE which is time-aligned with DL link 200, 220, and 240. At the UE, DL 220 transmitted by the RN may be detected as RN control channel 205. A remainder of DL link 260 may be a no reception period 265 according to MBSFN subframe definition.

R-PDCCH 209 resides in the search space which is the time-frequency region where R-PDCCH for a given RN may reside. A RN blindly searches for its R-PDCCH in its search space until finding it or finishes searching the search space without detection which means there is no R-PDCCH for this RN in this subframe. In FIGS. 2a through 2d, only one R-PDCCH is shown in search space 215, however, in general zero, one, or more R-PDCCHs may coexist in search space 215.

The RN only needs to examine within search space 215 for possible R-PDCCHs.

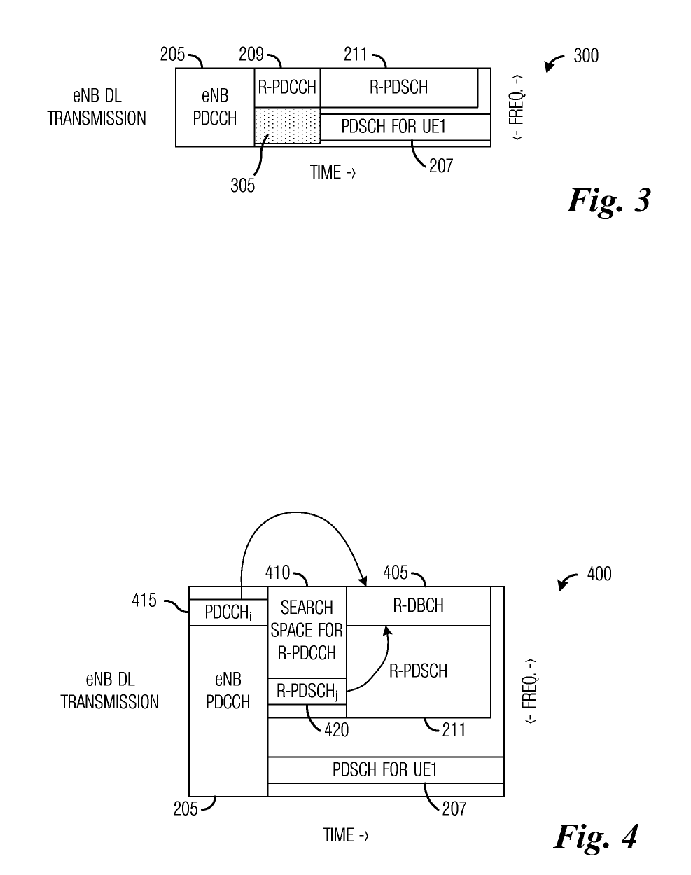

FIG. 3 illustrates a frame structure of a DL link 300. It is preferable that the subcarriers occupied by R-PDCCHs be assigned for DL transmission for RNs (not regular UEs like UE1 in FIG. 3) in a subframe. If this is not true, i.e., the OFDM symbols of the R-PDCCH subcarriers within the subframe are assigned to PDSCH of a regular UE such as UE1 in FIG. 3, the UE1 will not be aware that a subset of its PDSCH 207 resource elements have been allocated for use as R-PDCCH (denoted as damaged PDSCH symbols 305). Therefore, the UE1 will attempt to decode PDSCH 207 based on the Rel-8 design. In other words, UE1 will decode PDSCH 207 based on the received symbols of all of its PDSCH symbols. Due to the damaged PDSCH symbols (damaged PDSCH symbols 305), the performance of PDSCH 207 of the UE1 will be compromised to some extent. So it will be better to avoid any overlap between the common control region of R-PDCCHs and the PDSCHs.

The resource allocation for search space 215 of R-PDCCHs may vary with time to exploit the time-varying channel condition of the RNs. However, a RN must firstly blindly detect its R-PDCCH within its search space, and then acquire the indication information about its R-PDSCH. So there is a need of mechanisms to notify a RN where its search space is located. Both frequency domain and/or time domain resources of search space 215 need to be signalled to the RN to allow the RN to start R-PDCCH detection (blind detection).

A RN may find its control channel within its search space via blind detection if the donor eNB sends out a corresponding R-PDCCH. There may be several types of DL control information. For example, similar to regular DL control information (DCI), DL scheduling assignment or UL scheduling grant for the RN may also be categorized into several types of relay DL control information (R-DCI) formats. From a given R-PDCCH containing DL scheduling assignment, all the relevant information about the corresponding R-PDSCH may be obtained from a given R-PDCCH containing UL scheduling grant, all the relevant information about the corresponding R-PUSCH may be obtained.

The allocation of a search space (e.g., search space 215) can be indicated in several ways. It is natural that the allocation of a search space follows the search space design and/or mapping of Rel-8 and a virtual system bandwidth is needed to be defined to calculate the total number of the CCEs, N_{CCE,k} , in Rel-8, three types of RB allocations may also be utilized: types zero, one, and two.

In resource allocations of type 0, resource block assignment information includes a bitmap indicating the resource block groups (RBGs) that are allocated to the scheduled UE where a RBG is a set of consecutive virtual resource blocks (VRBs) of localized type. Resource block group size (P) is a function of the system bandwidth. The total number of RBGs (N_{RBG}) for downlink system bandwidth of N_{RB}^{DL} is given by N_{RBG}=┌N_{RB}^{DL}/P┐ where └N_{RB}^{DL}/P┘ of the RBGs are of size P and if N_{RB}^{DL} modP>0 then one of the RBGs is of size N_{RB}^{DL}−P. └N_{RB}^{DL}/P┘. The bitmap is of size N_{RBG} bits with one bitmap bit per RBG such that each RBG is addressable. The RBGs shall be indexed in the order of increasing frequency and non-increasing RBG sizes starting at the lowest frequency. The order of RBG to bitmap bit mapping is in such way that RBG 0 to RBG N_{RBG}−1 are mapped to MSB to LSB of the bitmap. The RBG is allocated to the UE if the corresponding bit value in the bitmap is 1, the RBG is not allocated to the UE otherwise.

In resource allocations of type 1, a resource block assignment information of size N_{RBG} indicates to a scheduled UE the VRBs from the set of VRBs from one of P RBG subsets. The virtual resource blocks used are of localized type. Also, P is the RBG size associated with the system bandwidth. A RBG subset p, where 0≦p<P, consists of every P -th RBG starting from RBG p. The resource block assignment information consists of three fields.
The first field with ┌log₂ (P)┐ bits is used to indicate the selected RBG subset among P RBG subsets.
The second field with one bit is used to indicate a shift of the resource allocation span within a subset. A bit value of 1 indicates shift is triggered. Shift is not triggered otherwise.
The third field includes a bitmap, where each bit of the bitmap addresses a single VRB in the selected RBG subset in such a way that MSB to LSB of the bitmap are mapped to the VRBs in the increasing frequency order. The VRB is allocated to the UE if the corresponding bit value in the bit field is 1, the VRB is not allocated to the UE otherwise.

In resource allocations of type 2, the resource block assignment information indicates to a scheduled UE a set of contiguously allocated localized virtual resource blocks or distributed virtual resource blocks. One bit flag sometimes is needed to indicate whether localized virtual resource blocks or distributed virtual resource blocks are assigned.

RB allocation types zero and one both support non-contiguous allocation of VRBs in the frequency domain, whereas type two supports contiguous allocations only. The RB allocation type to use should be selected as a compromise between the number of bits to send and the allocation flexibility. Compared to type two, types zero and one are more flexible, but also require significantly more bits especially when the bandwidth is large. Considering that allocation flexibility may not be important for search space 215, type two may be more appropriate to signal search space 215. This means that search space VRBs may be provided in the format of a start position and the length of the RB allocation.

Search spaces of different RNs for their R-PDCCHs (e.g., search space 215) may be located separately, may partly overlap like in Rel-8, or completely overlap for all RNs and the location of a search space may vary slowly. Therefore, dynamic allocation such as signaling every subframe may not be necessary. Rather, a slow RN-specific periodic or aperiodic signaling may meet the requirements by indicating allocation information of search space 215 for a period of time during which search space 215 does not change. Several types of signaling may be used. In one example, search space 215 may be signalled semi-statically via higher layer signalling such as Radio Resource Control (RRC) signaling. This is useful if the number of RNs served is small. In another example, search space 215 may be signalled in a subframe, which stays valid for several subframes. The starting time, ending time, and the periodicity information may be provided. The signaling mechanism can be a dynamic broadcast channel (DBCH) or physical downlink shared data channel (PDSCH). When the number of RNs served is large, the use of a DBCH is more efficient.

When designing the signaling of search space 215, it is preferred to use the same mechanism for all RNs regardless of their state. Here at least two states of RNs are considered. For example, when a RN powers up, the RN is in a state (referred to as “RN_DETACHED”) where it performs a cell search to attach to a donor eNB and is not visible to any UE as an eNB yet. In RN_DETACHED state, the RN appears to the donor eNodeB almost the same as a regular UE in that the backhaul link and the access link are not set up yet.

After performing attachment procedures with the donor eNB, the RN may move from RN_DETACHED state to a normal operation state (referred to as “RN_ACTIVE”) where it has both an active relay backhaul link and an active access link. When there are a number of RNs affiliated with a donor eNB, the RNs may be in different states at a given time. Thus it is necessary that the location information of search space 215 should be available for RNs in both RN_DETACHED and RN_ACTIVE states.

FIG. 4 illustrates a frame structure of a DL link 400. DL link 400 may be a generalized link transmitted by a donor eNB to one or more RNs, wherein each of the RNs being served by the donor eNB may be in RN_DETACHED or RN_ACTIVE states.

Since a search space of R-PDCCHs is RN-specific broadcast information, it should be transmitted like DBCH in PDSCH, shown as R-DBCH 405. Since this information may be meaningless for a common UE, it should not be seen by common UEs and consequently is not possible to reuse the existent UE group IDs: paging ID, S-Radio Network Temporary Identifier (RNTI), and so forth. So a brand new RNTI for a relay group to identify the allocation of a search space may therefore be defined: relay RNTI (R-RNTI).

With the R-RNTI, a RN in RN_DETACHED state can detect PDCCH 205 and then by PDCCH indication (PDCCHᵢ) acquire the corresponding PDSCH containing the common control region allocation, such as PDCCHᵢ 415. For RNs in RN_ACTIVE state, they can detect the R-PDCCH (in search space 410) and by R-PDCCH indication (R-PDCCHⱼ) acquire the corresponding R-PDSCH containing the search space allocation for next period of time, such as R-PDCCH_{J} 420. A common control region allocation information (R-DBCH 405) is pointed to by PDCCH and R-PDCCH of different relays as shown in FIG. 4.

When the allocation of R-DBCH 405 is indicated by PDCCHᵢ and by R-PDCCHⱼ, information regarding search space 410 provided in R-DBCH 405 are for future subframes. The R-DBCH is a transport channel, and is transmitted on the physical layer via the R-PDSCH. In order to share the same R-DBCH indicated by both PDCCHᵢ and R-PDCCHⱼ, the content of R-DBCH 405 is preferred to be resource allocation of a search space in a future subframe. R-DBCH 405 may provide two types of information:

Radio resource configuration. Radio resource configuration information includes both the time and the frequency information. In the frequency domain, the radio resource configuration may be in the format of start and length information in units of RB groups to specify the frequency subbands. In the time domain, the radio resource configuration may include the number of OFDM symbols occupied by search space 410 or the start and the end OFDM symbol for the search space, and

Timing information Timing information may include information in terms of subframe and/or radio frame. The starting valid time, end valid time, and the periodicity information of the radio resource configuration may be provided. In one example, the periodicity information may be provided in a bitmap, for example, where ‘0’ indicates a subframe that is not used for relay backhaul link, and ‘1’ indicates a subframe that is used for relay backhaul link. The bitmap may be used repetitively during a time period while the configuration is valid.

A starting OFDM symbol of R-DBCH 405 may need to be designed carefully. In the access link, an MBSFN subframe is used corresponding to the backhaul transmission. For the MBSFN subframe, a PDCCH could be one or two OFDM symbols, so the RNs could receive backhaul downlink signals from the 3^{rd} or 4^{th} OFDM symbols, respectively. Here it is assumed that the RNs need to insert a gap of one OFDM symbol after its transmission to allow for a switch to a receiving mode. While in relay backhaul link, the control region of eNB could occupy one, two, or three (or another integer number) OFDM symbols, that means that the PDSCH could be sent from the 2^{nd}, 3^{rd} or 4^{th} OFDM symbols.

To make sure all RNs in different statuses may acquire the common control region allocation simultaneously and precisely, R-DBCH 405 may be sent from a fixed symbol that all RNs can receive. Thus a simple way is to always start R-DBCH 405 at the n_{R-DBCH, 0}=4^{th} symbol. Alternatively, in the access link MBSFN subframe, PDCCH could be one OFDM symbol statically and the backhaul PDCCH could occupy less than three OFDM symbols statically, the n_{R-DBCH, 0}=3^{rd} symbol can set as a fixed start symbol, too. For example, the RN has only one or two antennas and the backhaul downlink subframe resources are mostly occupied by the RNs, so less common UEs are scheduled, then the PDCCH will occupy less symbols for indication. In summary, a fixed n_{R-DBCH, 0} value is preferred for simplicity.

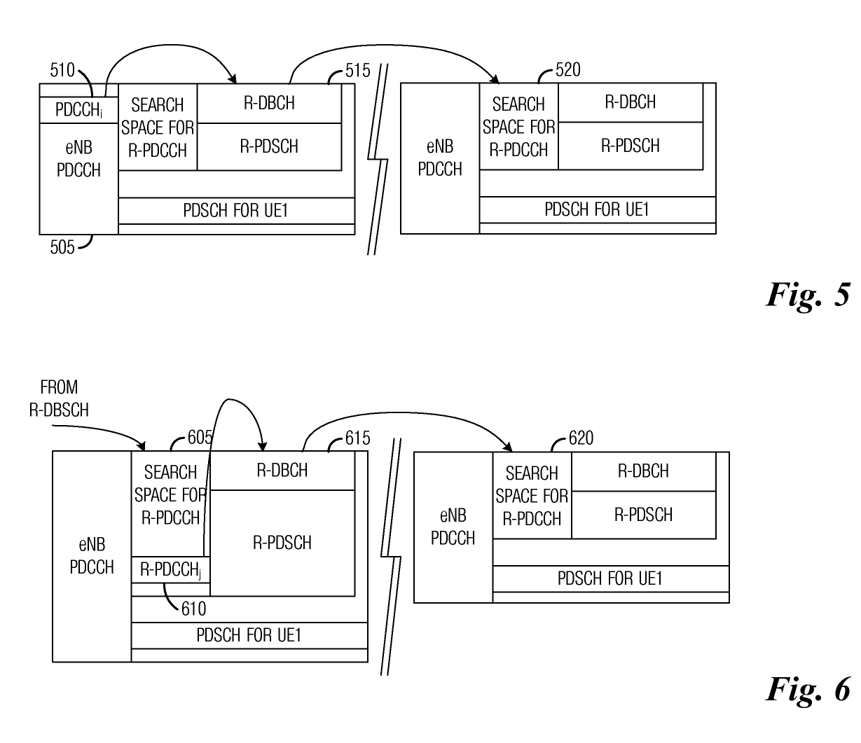

FIG. 5 illustrates a sequence of subframes of a relay backhaul link. The sequence of subframes illustrates the channels accessed by a RN as it initially connects to a donor eNB. As the RN initiates a message exchange to register as a RN for donor eNB, the donor eNB may include in its control region 505 a PDCCHᵢ 510 specifically addressed to the RN. As discussed previously, PDCCHᵢ 510 may include an indication of a location of a R-PDSCH carrying the R-DBCH, such as R-DBCH 515, within the same subframe. The R-DBCH contains information regarding a search space, such as search space 520, located in a subsequent subframe, where the RN may find its R-PDCCH information. In FIG. 5, although R-DBCH is carried by a R-PDSCH, R-DBCH 515 is so labeled within the data region to differentiate it from other types of the R-PDSCH carrying other information such as regular data.

FIG. 6 illustrates another sequence of subframes of a relay backhaul link. The sequence of subframes illustrates the channels accessed by a RN already being served by a donor eNB. Since the RN is already being served by the donor eNB, the RN has information regarding a search space, such as search space 605, where it can find its R-PDCCH information. However, if there will be a change to the search space or a location of the search space, the donor eNB may inform the RNs by using a R-PDCCH, such as R-PDCCHⱼ 610 to point to a R-DBCH 615 in R-PDSCH (within this subframe) containing the information regarding a new search space (in a subsequent subframe) where the RN may find its R-PDCCH information.

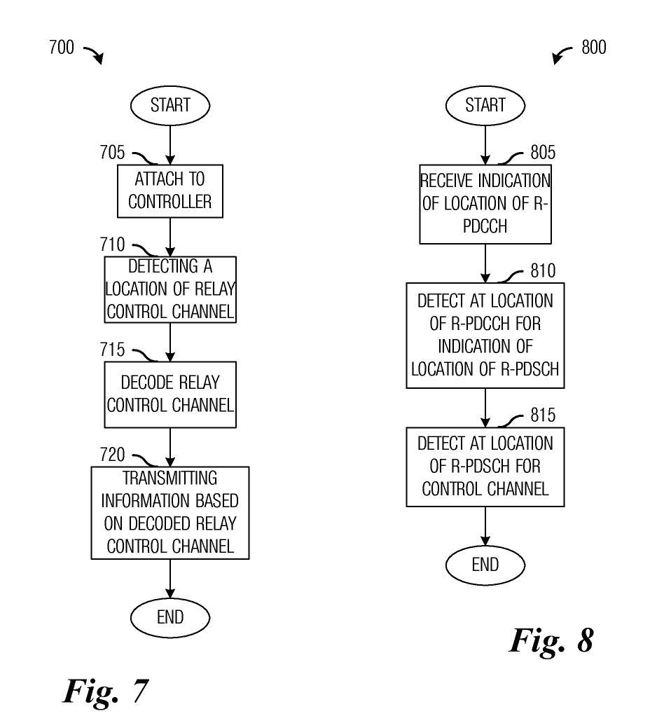

FIG. 7 illustrates a flow diagram of RN operations 700. RN operations 700 may be indicative of operations occurring in a RN, such as RN 115, as the RN detects and decodes a relay control channel and then transmits information based on information decoded from the relay control channel. RN operations 700 may occur when the RN initially joins a communications system or periodically at specified intervals after the RN has joined the communications system. RN operations 700 may occur while the RN is in a normal operating mode.

RN operations 700 may begin with the RN attaching to a controller of a communications system (block 705). According to an embodiment, the RN may attach to the controller when the RN initially joins the communications system, such as when it is initially powered on, after being reset/restarted, or so forth. After joining the communications system or at specified times, the RN may detect a location of a relay control channel (block 710). As discussed previously, the RN may search for an indicator of a location of the relay control channel.

With the location of the relay control channel known, the RN may search within the location of the relay control channel for its own relay control channel. If the RN finds its own relay control channel, the RN may decode the relay control channel (block 715). Then, based on information decoded from the relay control channel, the RN may transmit information to communications devices, including UE served by the RN as well as controller, e.g., an eNB, serving the RN (block 720). RN operations 700 may then terminate.

FIG. 8 illustrates a flow diagram of RN operations 800 in detecting a location of a relay control channel. RN operations 800 may be indicative of operations occurring in a RN as the RN attempts to determine a location of a search space, wherein the search space may contain a relay control channel for the RN. RN operations 800 may occur while the RN is in a normal operating mode. RN operations 800 may be an implementation of block 710 of FIG. 7.

RN operations 800 may begin with the RN receiving an indication of a location of a R-PDCCH (block 805). Alternatively, the indication may indicate a configuration of the resource blocks for the control channel, where the configuration of resources blocks may specify the control channel. The indication of the location of the R-PDCCH may be specifically addressed, e.g., the indication may include an identifier unique to the RN, to the RN and transmitted in a control channel transmitted by the controller.

The RN may then detect at the location of the R-PDCCH to find an indication of a location of a R-PDSCH (block 810). The R-PDCSCH may contain control information specific to the RN. The RN may then detect at the location of the R-PDSCH control information specifically intended for it. RN operations 800 may then terminate.

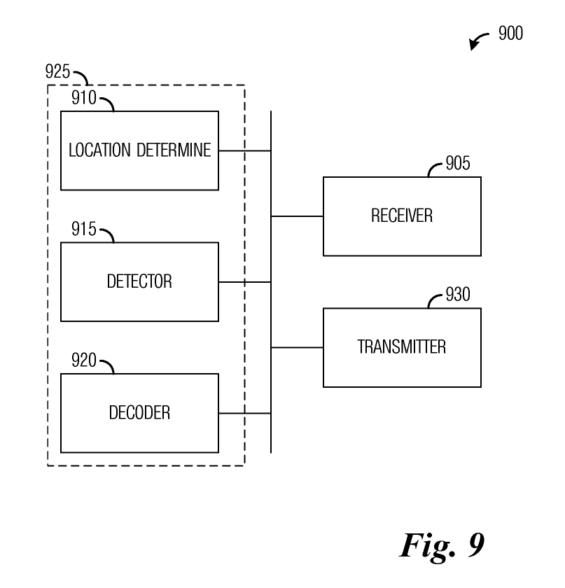

FIG. 9 provides an alternate illustration of a relay 900. Relay 900 may be used to implement various ones of the embodiments discussed herein. As shown in FIG. 9, a receiver 905 is configured to receive information. A location determine unit 910 is configured to determine a location of a relay control channel by searching for an indication of the relay control channel in the received information provided by receiver 905. A detector 915 is configured to detect the relay control channel within the location determined by location determine unit 910. As an example, detector 915 may use blind detection to detect the relay control channel. Since there may be multiple relay control channels, detector 915 may need to search for a relay control channel specifically addressed to relay 900. A decoder 920 is configured to decode information contained in the relay control channel. A transmitter 930 is configured to transmit information.

The elements of relay 900 may be implemented as specific hardware logic blocks. In an alternative, the elements of relay 900 may be implemented as software executing in a processor, controller, application specific integrated circuit, or so on. In yet another alternative, the elements of relay 900 may be implemented as a combination of software and/or hardware.

As an example, receiver 905 and transmitter 930 may be implemented as specific hardware blocks, while location determine unit 910, detector 915, and decoder 920 may be software modules executing in a processor 925 or custom compiled logic arrays of a field programmable logic array.

Additionally, an element of communications module 900 may include sub-elements.

Advantageous features of embodiments of the invention may include: a method for relay operation, the method comprising: attaching to a controller; receiving a first indication, wherein the first indication indicates a first location of a second indication, the second indication indicates a second location of a search space for a control channel; detecting the control channel at the second location indicated by the second indication; decoding the control channel; and transmitting information to a communications device based on information from the decoded control channel.

The method could further include, wherein attaching to a controller comprises, performing a cell search to find a controller. The method could further include, wherein receiving a first indication comprises, receiving a control channel indication specifically addressed to the relay in a control channel transmitted by the controller. The method could further include, wherein the control channel indication contains an identifier unique to the relay. The method could further include, wherein the identifier is assigned to the relay during the attaching. The method could further include, wherein the indication is contained in a control channel broadcast by the controller. The method could further include, wherein detecting the control channel comprises: detecting a dynamic broadcast channel at the first location, wherein the dynamic broadcast channel comprises the second indication; and searching for the control channel at the search space indicated by the second location. The method could further include, wherein the control channel is located in a group of resource blocks, wherein a resource block comprises time domain components and frequency domain components, wherein the group of resource blocks is non-contiguously allocated in the frequency domain or contiguously allocated in the frequency domain. The method could further include, wherein the group of resource blocks is contiguously allocated in the frequency domain, and wherein the second location comprises a starting resource block and a size of the group of resource blocks.

Advantageous features of embodiments of the invention may include: a method for relay operation, the method comprising: a) receiving a first indication; b) detecting a control channel in response to determining that the first indication indicates a search space for the control channel; c) detecting the control channel at a control channel location indicated by a second indication in response to determining that the indication does not indicate the search space for the control channel; d) decoding the control channel; and e) transmitting information to a communications device based on information from the decoded control channel.

The method could further include, wherein the first indication is conveyed in a transmission from a controller to the relay. The method could further include, wherein receiving a first indication comprises, searching a search space for the transmission. The method could further include, wherein the step b) comprises, blind detecting the control channel in the search space. The method could further include, wherein the step c) comprises: determining the control channel location by detecting the second indication at a location indicated by the first indication; and detecting the control channel at a search space indicated by the control channel indication.

Although the embodiments and their advantages have been described in detail, it should be understood that various changes, substitutions and alterations can be made herein without departing from the spirit and scope of the invention as defined by the appended claims Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for controller operation, the method comprising:
configuring a set of resource blocks for transmission of a relay control channel for a relay node, wherein the relay control channel is located within the set of resource blocks; and
transmitting the configuration of the set of resource blocks to the relay node using high layer signaling.

2. The method of claim 1, wherein the resource blocks in the set of resource blocks are physical resource blocks.

3. The method of claim 1, wherein the resource blocks in the set of resource blocks are virtual resource blocks.

4. The method of claim 3, wherein the virtual resource blocks are localized virtual resource blocks.

5. The method of claim 3, wherein the virtual resource blocks are distributed virtual resource blocks.

6. The method of claim 1, wherein the configuration is semi-statically assigned.

7. The method of claim 6, wherein the configuration is semi-statically assigned using radio resource control (RRC) signaling.

8. The method of claim 1, wherein time domain parameters of the resource blocks in the set of resource blocks are semi-statically assigned.

9. The method of claim 1, wherein the set of resource blocks defines a virtual system bandwidth within which the relay node searches for a relay control channel assigned to the relay node.

10. The method of claim 1, wherein the relay control channel occupies an integer number of resource blocks.

11. The method of claim 1, wherein the relay control channel occupies a subset of the resource blocks in the set of resource blocks.

12. The method of claim 1, wherein at the relay node, the relay node detects the relay control channel within the set of resource blocks.

13. The method of claim 12, wherein the relay control channel is detected using blind detection.

14. The method of claim 1, wherein a resource block comprises time domain components and frequency domain components, and wherein the set of resource blocks is non-contiguously allocated in the frequency domain.

15. The method of claim 1, wherein the set of resource blocks is contiguously allocated in a frequency domain.

16. A method for relay operation, the method comprising:
receiving a control channel indication, wherein the control channel indication indicates a resource block configuration for a relay control channel; and
detecting the relay control channel at a set of configured resource blocks specified by the resource block configuration.

17. The method of claim 16, wherein receiving the control channel indication comprises receiving an indication specifically addressed to a relay.

18. The method of claim 17, wherein the control channel indication is transmitted by a controller of the relay.

19. The method of claim 18, wherein the control channel indication comprises frequency domain information of the set of configured resource blocks.

20. The method of claim 18, wherein the control channel indication comprises time domain information of the set of configured resource blocks.

21. The method of claim 16, wherein the control channel is located in a group of resource blocks, wherein a resource block comprises time domain components and frequency domain components, and wherein the group of resource blocks is non-contiguously allocated in the frequency domain.

22. The method of claim 21, wherein the control channel is located in a group of resource blocks, wherein a resource block comprises time domain components and frequency domain components, and wherein the group of resource blocks is contiguously allocated in the frequency domain.

23. A transmission frame comprising:
a control region, wherein the control region comprises information specifically addressed to communications devices other than relay nodes;
a search space of a relay node, wherein a frequency location of the search space is signaled to the relay nodes by a controller;
a relay control channel, wherein the relay control channel comprises control information specifically addressed to the relay node, and wherein the relay control channel occupies a subset of the search space; and
a relay data channel, wherein the relay data channel comprises data specifically addressed to the relay node.

24. The transmission frame of claim 23, wherein the search space is a group of resource blocks contiguously allocated in a frequency domain, and wherein a resource block comprises time domain components and frequency domain components.

25. The transmission frame of claim 23, wherein the search space is a group of resource blocks non-contiguously allocated in a frequency domain, wherein a resource block comprises time domain components and frequency domain components.

26. A relay comprising:
a receiver configured to receive transmitted information;
a location unit coupled to the receiver, the location unit configured to determine a location of a relay control channel; and
a detector coupled to the location unit, the detector configured to detect the relay control channel within the location.

27. The relay of claim 26, wherein the detector searches for the relay control channel within a search space indicated by the location.

28. The relay of claim 27, wherein the detector uses blind detection to search for the relay control channel.

29. The relay of claim 26, further comprising a decoder coupled to the detector, the decoder configured to decode information from the relay control channel.
